(19) United States
(12) Patent Application Publication
(10) Pub. No.: US 2007/0229240 A1
(43) Pub. Date: Oct. 4, 2007

(54) Vehicle height detecting system

(75) Inventor: Keiji Yasuda, Handa-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/685,437

(22) Filed: Mar. 13, 2007

(30) Foreign Application Priority Data
Mar. 28, 2006 (JP) 2006-089170

(51) Int. Cl. B60C 23/02

(52) U.S. Cl. 340/442

(57) ABSTRACT

A vehicle height detecting system which detects a vehicle height level by transmitting and receiving a wireless wave signal between a wheel side and a vehicle body side of a vehicle, which includes a transmitting device provided at either one of the wheel side or the vehicle body side of the vehicle and transmitting the wireless wave signal, a receiving device provided at the other of the wheel side or the vehicle body side of the vehicle and receiving the wireless wave signal transmitted by the transmitting device, and a vehicle height detecting device detecting a level of the vehicle body on the basis of a time from transmitting the wireless wave signal by the transmitting device to receiving the wireless wave signal by the receiving device and/or on the basis of an intensity of the wireless wave signal received by the receiving device.

### CROSS REFERENCE TO RELATED APPLICATIONS

This application is based on and claims priority under 35 U.S.C. §119 with respect to Japanese Patent Application No. 2006-089170 filed on Mar. 29, 2006, the entire content of which is incorporated herein by reference.

### FIELD OF THE INVENTION

The present invention relates to a vehicle height detecting system which is readily mounted on a vehicle.

### BACKGROUND

Various vehicle height detecting systems, which detect a vehicle height level corresponding to a position of a sprung vehicle body relative to an unsprung wheel at a vehicle having a suspension mechanism, are disclosed. For example, by converting the one-dimensional displacement of, for example, a suspension arm into a rotational angle, a vehicle height level is detected according to JP10-002706A Further, according to JP62-014304U, for example, a vehicle height level and changes thereof are detected on the basis of the relative positional information of an inner cylinder and a rod constructing a condenser of a shock absorber based on a capacitance of the condenser.

With a construction where the vehicle height level is detected based on an amount of the one-dimensional displacement converted into the rotational angle, a mechanical link mechanism is required to generate rotational angles corresponding to the displacement amount. Thus, in case a construction, which detects a vehicle height level, requires a significant volume and displacement range of the detected displacement amount, the link mechanism cannot be mounted on the vehicle, which limits possibilities to detect a vehicle height level.

With a construction where the vehicle height level is detected on the basis of the relative positional information of the inner cylinder and the rod in the shock absorber, it is required to house a sensor in a small space, which limits the size of the sensor. In addition, because the temperature of the shock absorber is likely to be high, it is required to take measures to prevent failure of the sensor.

A need thus exists for a vehicle height detecting system, which is readily mounted on a vehicle.

### SUMMARY OF THE INVENTION

In light of the foregoing, an aspect of the present invention provides a vehicle height detecting system which detects a vehicle height level by transmitting and receiving a wireless wave signal between a wheel side and a vehicle body side of a vehicle, which includes a transmitting means provided at either one of the wheel side or the vehicle body side of the vehicle and transmitting the wireless wave signal, a receiving means provided at the other of the wheel side or the vehicle body side of the vehicle and receiving the wireless wave signal transmitted by the transmitting means, and a vehicle height detecting means detecting a level of the vehicle body on the basis of a time from transmitting the wireless wave signal by the transmitting means to receiving the wireless wave signal by the receiving means and/or on the basis of an intensity of the wireless wave signal received by the receiving means.

According to the present invention, a vehicle height level (i.e., level of a vehicle body) is detected by transmitting and receiving a predetermined wireless wave signal between a wheel side and a vehicle body side of a vehicle. This construction does not require a mechanical link mechanism, and thus the vehicle height detecting system can be readily mounted on the vehicle. Further, because it is not necessary to install a special structure to a suspension mechanism such as a case where the vehicle height detecting device is provided in a shock absorber and also it is not necessary to provide measures to prevent to be influenced by the high temperature, the vehicle height detecting system can be readily mounted on the vehicle.

### BRIEF DESCRIPTION OF THE DRAWINGS

The foregoing and additional features and characteristics of the present invention will become more apparent from the following detailed description considered with reference to the accompanying drawings, wherein:

FIG. 1 is a block view showing a vehicle height detecting system according to a first embodiment of the present invention.

FIG. 2 is an explanatory view showing an example of an arrangement of a wheel side transmitting portion and a vehicle body side receiving portion of a vehicle.

FIG. 3 is an explanatory view showing a transmitting and receiving operation of a wireless wave signal at the vehicle height detecting system according to the first embodiment of the present invention.

FIG. 4 is a block view showing a vehicle height detecting system according to a second embodiment of the present invention.

FIG. 5 is an explanatory view showing a transmitting and receiving operation of a wireless wave signal at the vehicle height detecting system according to the second embodiment of the present invention.

### DETAILED DESCRIPTION

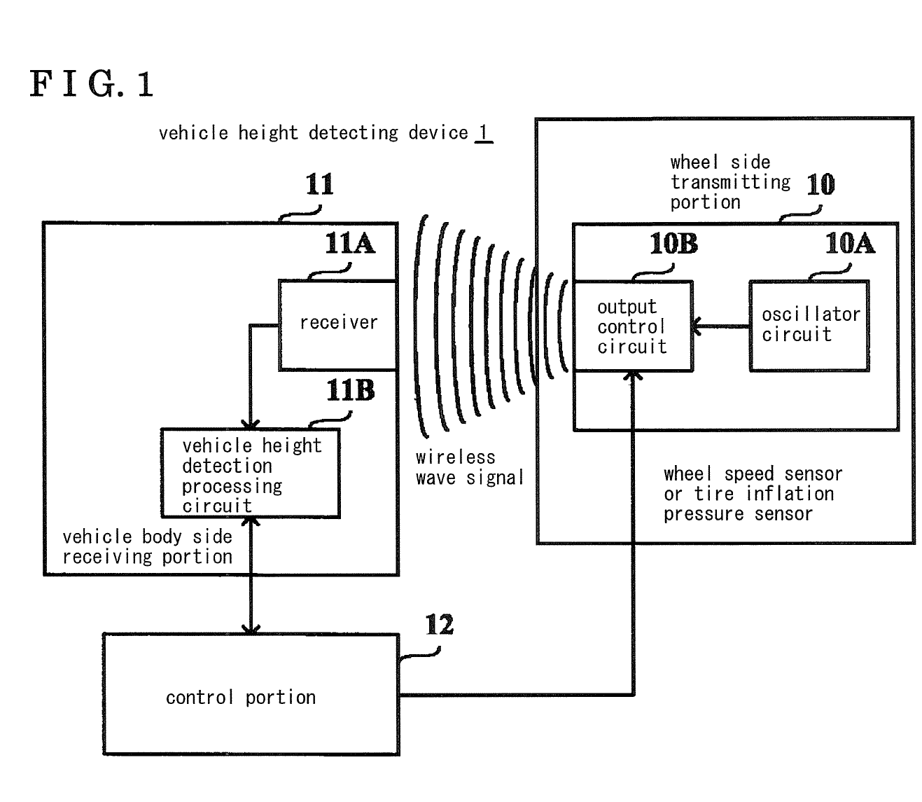

Embodiments of the present invention will be explained with reference to illustrations of drawings as follows. A first embodiment of the present invention will be explained referring to FIGS. 1-3. FIG. 1 shows a vehicle height detecting system 1 according to the first embodiment of the present invention.

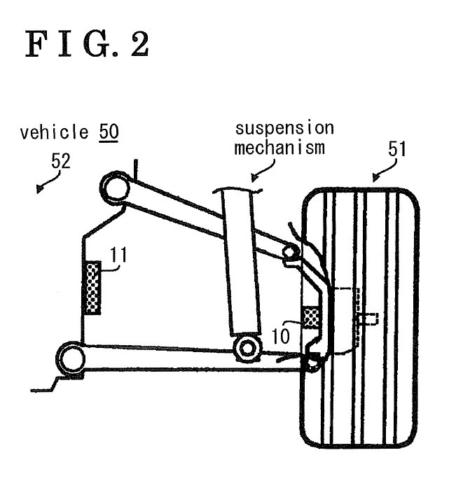

As shown in FIG. 1, the vehicle height detecting system 1 includes a wheel side transmitting portion 10 (i.e., serving as a transmitting means), a vehicle body side receiving portion 11, and a control portion 12. The wheel side transmitting portion 10 and the vehicle body side receiving portion 11 are arranged on a vehicle 50 having a suspension mechanism as shown in FIG. 2.

The wheel side transmitting portion 10 shown in FIGS. 1-2 is arranged at each unsprung wheel 51, of the vehicle 50 and, for example, transmits a wireless wave signal. As a wireless wave signal transmitted from the wheel side transmitting portion 10, for example, an electromagnetic wave including an infrared ray and an electric pulse or an ultrasonic wave, may be applied. In those circumstances, for example, the wheel side transmitting portion 10 may be mounted on a wheel speed sensor which is positioned at a wheel 51 to detect the wheel speed at an antilock brake apparatus for performing an antilock braking control of the vehicle 50. Further, the wheel side transmitting portion 10 may be mounted on a tire inflation pressure sensor which is positioned at the wheel 51 in order to detect a tire inflation pressure at a tire inflation pressure monitoring system which is configured to monitor a tire inflation pressure of the vehicle 50. The wireless wave signal transmitted from the wheel side transmitting portion 10 is transmitted with a predetermined radial angle. Further, the wireless wave signal transmitted from the wheel side transmitting portion 10 may include a predetermined directivity.

As shown in FIG. 1, for example, the wheel side transmitting portion 10 includes an oscillator circuit 10A which generates a wireless wave signal such as an electromagnetic wave or an ultrasonic wave, and an output control circuit 10B which controls an outputting operation of the wireless wave signal generated in the oscillator circuit 10A. The output control circuit 10B switches starting or stopping outputting the wireless wave signal generated by the oscillator circuit 10A on the basis of transmission control information obtained from the control portion 12.

The vehicle body side receiving portion 11 shown in FIGS. 1-2 is positioned at a sprung vehicle body 52 of the vehicle 50 and receives the wireless wave signal transmitted from the wheel side transmitting portion 10. In those circumstances, because the wireless wave signal transmitted from the wheel side transmitting portion 10 is transmitted with the predetermined radial angle, even when a relative position of the unsprung wheel 51 to the sprung vehicle body 52 is changed at the vehicle 50, the vehicle body side receiving portion 11 can receive the wireless wave signal transmitted from the wheel side transmitting portion 10. As shown in FIG. 1, for example, the vehicle body side receiving portion 11 includes a receiver 11A (i.e., serving as a receiving means), which receives the wireless wave signal, and a vehicle height detection processing circuit 11B (i.e., serving as a vehicle height detecting means and a calculation processing means), which specifies a level of the vehicle body 52 of the vehicle 50 on the basis of a receiving timing of the wireless wave signal and an intensity of the received wireless wave signal at the receiver 11A. The vehicle height level detected information which shows the level of the vehicle body specified by the vehicle height detection processing circuit 11B is transmitted to the control portion 12.

The control portion 12, for example, includes an on-vehicle microcomputer such as an ECU (i.e., Electronic Control Unit) which produces the transmission control information which is to be provided to the wheel side transmitting portion 10 and the vehicle body side receiving portion 11 and which obtains the vehicle height level detected information provided by the vehicle body side receiving portion 11. The transmission control information produced by the control portion 12 is the information which shows a transmitting timing for periodically transmitting the wireless wave signal from the wheel side transmitting portion 10 to the vehicle body side receiving portion 11. Particularly, for example, the control portion 12 includes a ROM (i.e., Read Only Memory) which stores various setting data and program(s) readable by the computer in advance, a RAM (i.e., Random Access Memory) which loads the program(s) stored in the ROM and provides a working area, a CPU (i.e., Central Processing Unit) which executes various processing following the program(s) stored in the ROM, and an interface circuit connected to an in-vehicle network such as an on-vehicle LAN (i.e., Local Area Network) including a CAN (i.e., Car Area Network) and a LIN (Local Interconnect Network).

The control portion 12 may perform various controls related to an operation of the vehicle 50 in accordance with a vehicle height (i.e., level of the vehicle body) indicated in the vehicle height level detected information. For example, the control portion 12 may control an operation of various suspension mechanisms such as an air suspension and a hydraulic suspension. For example, the control portion 12 may control a stiffness of a suspension mechanism in accordance with a change of a vehicle height (i.e., a change of the level of the vehicle body). Further, the control portion 12 may control a direction of radiation of headlights in accordance with a change of the vehicle height (i.e., the level of the vehicle body) detected for each wheel 51 of the vehicle 50.

An operation of the vehicle height detecting system 1 according to the first embodiment of the present invention will be explained as follows. With the construction of the vehicle height detecting system 1, the transmission control information produced at the control portion 12 is transmitted to the wheel side transmitting portion 10 and the vehicle body side receiving portion 11. In those circumstances, the transmission of the transmission control information from the control portion 12 to the wheel side transmitting portion 10 may be performed using a wiring separately provided from other wirings. Instead of the foregoing construction, the transmission of the transmission control information from the control portion 12 to the wheel side transmitting portion 10 may be performed using a wiring provided along with wirings for an antilock braking system and a tire inflation pressure monitoring system or may be performed using the wirings for the antilock braking system and the tire inflation pressure monitoring system per se.

For example, when the wheel side transmitting portion 10 is mounted on a wheel speed sensor of an antilock braking system provided at the vehicle 50, the transmission control information is transmitted from the control portion 12 to the wheel side transmitting portion 10 using a wiring which is provided along with a wiring for the antilock braking system or the wiring for the antilock braking system per se. Further, when the wheel side transmitting portion 10 is mounted on a tire inflation pressure sensor of a tire inflation pressure monitoring system provided at the vehicle 50, the transmission control information is transmitted from the control portion 12 to the wheel side transmitting portion 10 using a wiring provided along with a wiring for the tire inflation pressure monitoring system or the wiring for the tire inflation pressure monitoring system per se.

Further, the transmission of the transmission control information from the control portion 12 to the wheel side transmitting portion 10 may be performed using a wireless wave signal which is different from the wireless wave signal transmitted from the wheel side transmitting portion 10. For example, when an ultrasonic wave is applied as a wireless wave signal transmitted from the wheel side transmitting portion 10 to the vehicle body side receiving portion 11, the transmission control information may be transmitted from the control portion 12 to the wheel side transmitting portion 10 using a radio signal such as an electromagnetic wave. In case an electromagnetic wave such as a radio signal (including a infrared ray) having a predetermined frequency is applied as a wireless wave signal transmitted from the wheel side transmitting portion 10 to the vehicle body side receiving portion 11, the transmission control information may be transmitted from the control portion 12 to the wheel side transmitting portion 10 using a radio signal (including a infrared ray) having a frequency which is different from the predetermined frequency of the radio signal transmitted from the wheel side transmitting portion 10 to the vehicle body receiving portion 11 or using a radio signal transmitted at a timing different from a transmitting timing from the wheel side transmitting portion 10 to the vehicle body receiving portion 11.

The transmission of the transmission control information from the control portion 12 to the vehicle body receiving portion 11 may be performed using a wiring which is exclusively provided separately from other wirings. Instead of the foregoing construction, the transmission of the transmission control information from the control portion 12 to the vehicle body receiving portion 11 may be performed using general wiring applied with in-vehicle network such as a LAN mounted on a vehicle including a CAN and LIN, or the like.

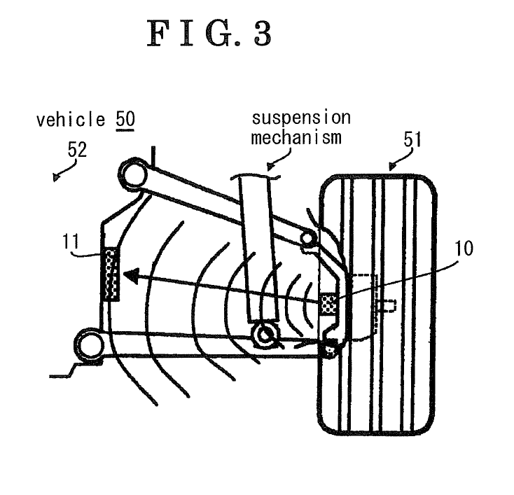

At the wheel side transmitting portion 10, the wireless wave signal generated at the oscillator circuit 10A is periodically transmitted to the vehicle body side receiving portion 11 at a transmission timing indicated in the transmission control information, on the basis of a control by the output control circuit 10B. By the transmission of the wireless wave signal from the wheel side transmitting portion 10, for example as shown in FIG. 3, the wireless wave signal transmitting from the wheel side transmitting portion 10 at a predetermined transmitting timing reaches the vehicle body side receiving portion 11.

At the vehicle body side receiving portion 11, the vehicle height detection processing circuit 11B executes a processing for specifying a level of the vehicle body 52 of the vehicle 50 on the basis of a timing of receiving the wireless wave signal and an intensity of the receiving signal of the wireless wave signal to the receiver 11A. In those circumstances, in case a pitch direction of the vehicle body 52 which is a direction in which the vehicle height level changes at the vehicle 50 includes a component vertical to a direction of a wave front of the wireless wave signal which is transmitted from the wheel side transmitting portion 10, a path of the wireless wave signal differs in accordance with a change of the vehicle height (i.e., the level of the vehicle body). Those differences of the paths of the wireless wave signal fluctuate time duration from transmitting to receiving the wireless wave signal. Accordingly, the vehicle height detection transmitting circuit 11B may execute a processing for detecting the level of the vehicle 50 on the basis of time duration from transmitting the wireless wave signal at the wheel side transmitting portion 10 to receiving the wireless wave signal at the vehicle body side receiving portion 11. The vehicle height detection processing circuit 11B estimates the intensity of the wireless wave signal on the basis of a difference of a peak value of the wireless wave signal and a successive peak value of the wireless wave signal.

For example, the vehicle height detection processing circuit 11B includes a data memory (e.g., a ROM, flash memory, or the like) in which a time/vehicle height data conversion table, which shows correspondences of vehicle height levels and time durations from transmitting to receiving the wireless wave signal, which has specified by a test in advance, is stored. The transmission control information which indicates a timing of transmitting the wireless wave signal at the wheel side transmitting portion 10 is provided from the control portion 12 to the vehicle height detection processing circuit 11B. Thereafter, the vehicle height detection transmitting circuit 11B specifies a time duration from transmitting to receiving the wireless wave signal on the basis of a receiving timing receiving the wireless wave signal by the receiver 11A and a transmitting timing indicated in the transmission control signal. A vehicle height level (i.e., a level of the vehicle body) can be detected (i.e., calculated) by converting the time duration from transmitting to receiving the wireless wave signal into the vehicle height data (i.e., information) corresponding to the specified time duration, referring to the time/vehicle height data conversion table based on the specified time duration from transmitting to receiving the wireless wave signal (i.e., the level of the vehicle body can be obtained on the basis of the time duration from transmitting to receiving the wireless wave signal to the vehicle height data).

In case the wireless wave signal includes a predetermined radial angle, an intensity of receiving signal of the wireless wave signal is fluctuated in accordance with differences of paths of the wireless wave signal at a receiving position. For example, when a receiving position of the wireless wave signal is positioned farther from a transmitting position of the wireless wave signal, the wireless wave signal is attenuated by radiation diffusion to decline the intensity of the wireless wave signal received at the receiving position. In addition, in case the wireless wave signal includes a predetermined directivity, the intensity of the received wireless wave signal is fluctuated in accordance with a radial angle at the receiving position. Accordingly, the vehicle height detection processing circuit 11B may execute a processing to detect a level of the vehicle 50 on the basis of the intensity of the wireless wave signal received at the vehicle body side receiving portion 11.

For example, the vehicle height detection processing circuit 11B includes a data memory in which an intensity/vehicle height data conversion table, which indicates correspondences of the vehicle height level (i.e., level of the vehicle body) and the intensity of the received wireless wave signal, which has been specified by a test in advance, is stored. The vehicle height detection processing circuit 11B can detect (i.e., calculate) a vehicle height level (i.e., level of the vehicle body) by converting the intensity of the received wireless wave signal at the receiver 11A into the corresponding vehicle height level referring to the intensity/vehicle height data conversion table (i.e., the level of vehicle body can be obtained on the basis of the intensity of the received wireless wave signal).

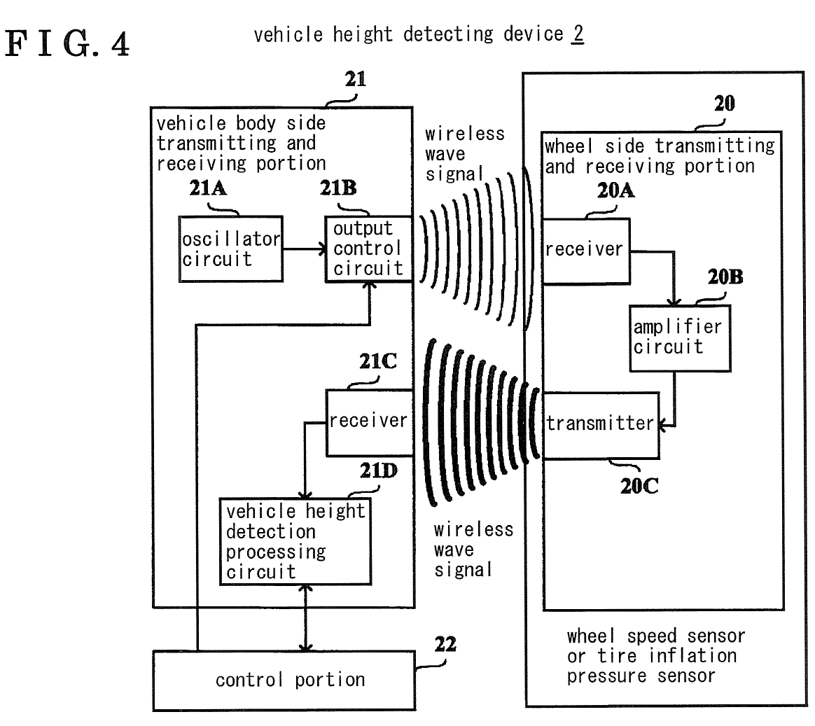

A vehicle height detecting system according to a second embodiment of the present invention will be explained as follows. As shown in FIG. 4, a vehicle height detecting system 2 includes a wheel side transmitting and receiving portion 20 (i.e., serving as a transmitting means), a vehicle body side transmitting and receiving portion 21, and a control portion 22.

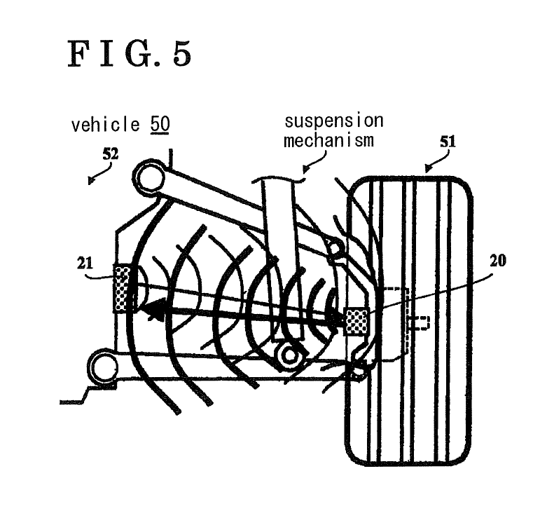

The wheel side transmitting and receiving portion 20 shown in FIG. 4 is, likewise the arrangement of the wheel side transmitting portion 10 shown in FIG. 2, provided at the unsprung wheel 51 of the vehicle 50 having a suspension mechanism (shown in FIG. 5). The wheel side transmitting and receiving portion 20 may be, likewise the wheel side transmitting portion 10 of the first embodiment, mounted on a wheel speed sensor which is arranged at the wheel 51 to detect wheel speed at an antilock braking system which performs an antilock braking control of the vehicle 50. Instead of the foregoing construction, the wheel side transmitting and receiving portion 20 may be mounted on a tire inflation pressure sensor which is arranged at the wheel 51 to detect a tire inflation pressure at a tire inflation pressure monitoring system which monitors tire inflation pressure of the vehicle 50.

The wheel side transmitting and receiving portion 20 includes a receiver 20A which is configured to receive a wireless wave signal, an amplifier circuit 20B (i.e., serving as a signal amplifying means) which amplifies the wireless wave signal received by the receiver 20A, and a transmitter 20C (i.e., serving as an amplified signal transmitting means) which transmits the wireless wave signal amplified by the amplifier circuit 20B to the vehicle body side transmitting and receiving portion 21. In those circumstances, for example, an electromagnetic wave including an infrared ray and an electric pulse or an ultrasonic wave may be applied as the wireless wave signal received by the receiver 20A and the wireless wave signal transmitted by the transmitter 20C. The wireless wave signal transmitted from the transmitter 20C includes a predetermined radial angle. Further, the wireless wave signal transmitted from the transmitter 20C may include a predetermined directivity.

The vehicle body side transmitting and receiving portion 21 may be, likewise the arrangement of the vehicle body side receiving portion 11 of the first embodiment shown in FIG. 2, arranged at the sprung vehicle body 52 at the vehicle 50 having a suspension mechanism (shown in FIG. 5). The vehicle body side transmitting and receiving portion 21 includes an oscillator circuit 21A which generates a wireless wave signal, an output control circuit 21B (i.e., serving as a vehicle body side transmitting means) which controls an outputting operation of the wireless wave signal generated by the oscillator circuit 21A, a receiver 21C (i.e., serving as a receiving means) which receives the wireless wave signal which is transmitted from the wheel side transmitting and receiving portion 20, and a vehicle height detection processing circuit 21D (i.e., serving as a vehicle height detecting means and as a calculation processing means) which specifies a vehicle height level on the basis of a receiving timing of the wireless wave signal and the intensity of the received wireless wave signal at the receiver 21C. The oscillator circuit 21A, the output control circuit 21B, the receiver 21C, and the vehicle height detection processing circuit 21D may include constructions likewise the oscillator circuit 10A, the output control circuit 10B, the receiver 11A, and the vehicle height detection processing circuit 11B of the first embodiment, respectively. The wireless wave signal transmitted from the vehicle body side transmitting and receiving portion 21 includes a predetermined radial angle. The wireless wave signal transmitted from the vehicle body side transmitting and receiving portion 21 may include a predetermined directivity.

The control portion 22 produces the transmission control information which is to be provided to the vehicle body side transmitting and receiving portion 21 and obtains the vehicle height level detected information provided by the vehicle body side transmitting and receiving portion 21. The transmission control information produced by the control portion 22 is the information which indicates a timing to periodically transmit the wireless wave signal from the vehicle body side transmitting and receiving portion 21 to the wheel side transmitting and receiving portion 20. In case the vehicle body side transmitting and receiving portion 21 per se includes a function to periodically transmit the wireless wave signal to the wheel side transmitting and receiving portion 20, it is not necessary to provide the transmission control information from the control portion 22 to the vehicle body side transmitting and receiving portion 21. The control portion 22 may include a construction likewise the construction of the control portion 12 of the first embodiment. Further, likewise the control portion 12 of the first embodiment, the control portion 22 may perform various controls for operations of the vehicle 50 in accordance with the vehicle height indicated in the vehicle height level detected information.

An operation of the vehicle height detecting system 2 according to the second embodiment of the present invention will be explained as follows. With the construction of the vehicle height detecting system 2, the transmission control information produced at the control portion 22 is transmitted to the vehicle body side transmitting and receiving portion 21. In those circumstances, the transmission control information may be transmitted from the control portion 22 to the vehicle body transmitting and receiving portion 21 using a wiring exclusively provided separately from other wirings. Instead of the foregoing construction, the transmission control information may be transmitted from the control portion 22 to the vehicle body side transmitting and receiving portion 21 using general wirings applied to an in-vehicle network such as a LAN mounted on a vehicle including a CAN and LIN, or the like. Further, in case a timing for transmitting the wireless wave signal can be controlled at the vehicle body side transmitting and receiving portion 21 independently, it is not necessary to transmit the transmission control information from the control portion 22 to the vehicle body transmitting and receiving portion 21.

At the vehicle body side transmitting and receiving portion 21, the wireless wave signal generated at the oscillator circuit 21A is periodically transmitted to the wheel side transmitting and receiving portion 20 at a predetermined transmission timing on the basis of a control by the output control circuit 21B. Because the wireless wave signal transmitted from the vehicle body side transmitting and receiving portion 21 includes a predetermined radial angle, the wireless wave signal transmitted from the vehicle body side transmitting and receiving portion 21 can be received at the wheel side transmitting and receiving portion 20 even when the relative position of the unsprung wheel 51 and the sprung vehicle body 52 is changed at the vehicle 50.

At the wheel side transmitting and receiving portion 20, after amplifying the wireless wave signal which has been received by the receiver 20A at the amplifier circuit 20B, the wireless wave signal is transmitted to the vehicle body side transmitting and receiving portion 21 by the transmitter 21C. Accordingly, after an elapse of a predetermined lag time (i.e., time required for amplification) from the receiving timing of the wireless wave signal at the receiver 20A, for example as shown with a bold arrow in FIG. 5, the received wireless wave signal is amplified and transmitted from the transmitter 20C to the vehicle body side transmitting and receiving portion 21.

At the vehicle body side transmitting and receiving portion 21, the vehicle height detection processing circuit 21D executes a processing which specifies a vehicle height level of the vehicle body 52 of the vehicle 50 on the basis of a receiving timing of the wireless wave signal and an intensity of the received wireless wave signal at the receiver 21C. In those circumstances, the vehicle height detection processing circuit 21D may execute a processing to detect a vehicle height level of the vehicle 50 on the basis of time from transmitting the wireless wave signal at the vehicle body side transmitting and receiving portion 21 towards the wheel side transmitting and receiving portion 20 until receiving the wireless wave signal transmitted from the transmitter 20C of the wheel side transmitting and receiving portion 20 at the receiver 21C. In those circumstances, the time from transmitting to receiving the wireless wave signal may or may not include a time for amplification which is required after receiving the wireless wave signal by the receiving portion 20A until transmitting the wireless wave signal by the transmitter 20C via an amplification process at the amplifier circuit 20B. The time for amplification may be specified by a test in advance.

For example, the vehicle height detection transmitting circuit 21D includes a data memory in which a time/vehicle height data conversion table, which indicates correspondences of vehicle height levels and times required from transmitting to receiving the wireless wave signal specified in advance by a test, is stored. The vehicle height detection transmitting circuit 21D specifies the time from transmitting to receiving the wireless wave signal on the basis of a receiving timing of receiving the wireless wave signal by the receiver 21D, a transmitting timing indicated in the transmission control signal from the control portion 22, and a transmitting timing determined by the output control circuit 21B, or the like. In those circumstances, in case the time for amplification is included in the time required from transmitting to receiving the wireless wave signal, a time difference deducting a time of the transmitting timing from a time of the receiving timing may be specified as the time from transmitting to receiving the wireless wave signal. On the other hand, in case the time for amplification is not included in the time required from transmitting to receiving the wireless wave signal, a time difference deducting a time of transmitting timing and the time for amplification from the time of the receiving timing may be specified as the time from transmitting to receiving the wireless wave signal. On the basis of the time from transmitting to receiving the wireless wave signal specified accordingly, a vehicle height level (i.e., level of the vehicle body) can be detected (i.e., calculated) by converting the time from transmitting to receiving the wireless wave signal to the corresponding vehicle height level data referring to the time/vehicle height data conversion table (i.e., the level of the vehicle body can be obtained on the basis of the time from transmitting to receiving the wireless wave signal).

Further, at the vehicle height detection processing circuit 21D, a processing for detecting a vehicle height level (i.e., level of the vehicle body) at the vehicle 50 may be executed on the basis of an intensity of the wireless wave signal received by the vehicle body side transmitting and receiving portion 21. For example, the vehicle height detection processing circuit 21D includes a data memory in which an intensity/vehicle height data conversion table, which indicates correspondences of vehicle height levels and intensities of the received wireless wave signal specified in advance by a test, is stored. On the basis of the intensity of the received wireless wave signal at the receiver 21C, the vehicle height detection processing circuit 21D can detect (i.e., calculate) a vehicle height level by converting the intensity of the received wireless wave signal into the corresponding vehicle height level data referring to the intensity/vehicle height data conversion table (i.e., the level of the vehicle body can be obtained on the basis of the intensity of the received wireless wave signal).

As explained above, with the construction of the vehicle height detecting system 1 according to the first embodiment and the vehicle height detecting system 2 according to the second embodiment of the present invention, a vehicle height level can be detected on the basis of a time from transmitting to receiving the wireless wave signal such as an electromagnetic wave or an ultrasonic wave and on the basis of an intensity of the received wireless wave signal without applying a mechanical link mechanism. According to the foregoing construction, an increase of the vehicle height detecting system in size can be prevented and the vehicle height detecting system can be readily mounted on the vehicle. Further, because the vehicle height detecting system can be provided on an arbitrary position at which the wireless wave signal can be transmitted and received at the wheel 51 and at the vehicle body 52 of the vehicle 50, there is no limitation for assembling the system because of a size, for example when assembling the vehicle height detecting system in a shock absorber. Still further, because the vehicle height detecting system according to the embodiments of the present invention can be provided at a position other than high temperature such as in the shock absorber, which does not require special measures to prevent to be influenced by the high temperature, the vehicle height detecting system can be readily provided.

In addition, according to the first and second embodiments of the present invention, for example, because it is not necessary to install a special structure to a suspension mechanism like a case where the vehicle height detecting system is provided in the shock absorber, the vehicle height detecting system can be readily mounted on the vehicle irrespective of structures and variations of suspension mechanisms. Further, when the wheel side transmitting portion 10 and the wheel side transmitting and receiving portion 20 are mounted at a tire inflation pressure sensor of a tire inflation pressure monitoring system and a wheel speed sensor of an antilock braking system, just by modifying the sensors, the vehicle height detecting system can be readily mounted on the vehicle without changing wirings and positioning.

According to the first and second embodiments of the present invention, because the wireless wave signal is transmitted and received in a shorter distance compared to a construction in which a vehicle height level (i.e., level of the vehicle body) is detected by receiving a reflected wave such as an ultrasonic wave which has been transmitted to a road surface, for example, the wireless wave signal can be detected with high sensitivity and the vehicle height level can be detected with higher precision. Further, compared to detecting a vehicle height level, for example, by receiving a reflected wave of an ultrasonic wave transmitted to, for example, a road surface, an influence of a cause of noises such as a change of road configuration can be reduced, which enables the vehicle height detecting system to detect a vehicle height level with higher precision.

With the construction of the vehicle height detecting system 2 according to the second embodiment of the present invention, compared to the vehicle height detecting system 1 of the first embodiment, path differences of the wireless wave signal in accordance with a change of the vehicle height level is increased. Accordingly, a range of the time from transmitting to receiving the wireless wave signal and a range of intensities of the received wireless wave signal are wider than the construction of the first embodiment, and the vehicle height level can be detected with higher precision. Further, with the construction of the vehicle height detecting system 2 according to the second embodiment of the present invention, because the wireless wave signal received by the receiver 20A is transmitted by the transmitter 20C after amplifying at the amplifier circuit 20B at the wheel side transmitting and receiving portion 20, range of intensities of the received wireless wave signal in accordance with a change of the vehicle height level can be greater, which enables the vehicle height detecting system to detect the vehicle height level with higher precision.

The present invention is not limited to the foregoing embodiments and may be varied. For example, with the construction of the foregoing embodiments, the vehicle height detection processing circuit 11B is provided at the vehicle body side receiving portion 11 and the vehicle height detection processing circuit 21D is provided at the vehicle body side transmitting and receiving portion 21. However, the present invention is not limited to the foregoing constructions, and the vehicle height detection processing circuit 11B may be provided at the control portion 12 and the vehicle height detection processing circuit 21D may be provided at the control portion 22.

Further, a structure corresponding to the wheel side transmitting portion 10 or the wheel side transmitting and receiving portion 20 may be provided at the vehicle body 52 of the vehicle 50 and a structure corresponding to the vehicle body side receiving portion 11 and the vehicle body side transmitting and receiving portion 21 may be provided at the wheel 51 of the vehicle 50.

According to the embodiments of the present invention, a vehicle height level (i.e., level of a vehicle body) is detected by transmitting and receiving a predetermined wireless wave signal between a wheel side and a vehicle body side of a vehicle. This construction does not require a mechanical link mechanism, and thus the vehicle height detecting system can be readily mounted on the vehicle. Further, because it is not necessary to install a special structure to a suspension mechanism such as a case where the vehicle height detecting device is provided in a shock absorber and also it is not necessary to provide measures to prevent to be influenced by the high temperature, the vehicle height detecting system can be readily mounted on the vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle height detecting system for use in a vehicle, comprising:
transmitting means, adapted for being provided at either one of the wheel structure and the vehicle body structure, for transmitting a radio wave signal;
receiving means, adapted for being provided at the other of the wheel structure and the vehicle body structure, for receiving the radio wave signal from the transmitting means; and
vehicle height detecting means for determining a ground level of the vehicle on the basis of an intensity of the radio wave signal received at the receiving means and/or a time duration between an initiation of the transmission of the radio wave signal from the transmitting means to the reception thereof at the receiving means.

2. The vehicle height detecting system according to claim 1, wherein the vehicle height detecting means comprises a calculation processing means which obtains information of the level of the vehicle body of the vehicle on the basis of the time from transmitting the wireless wave signal by the transmitting means to receiving the wireless wave signal by the receiving means and/or the intensity of the wireless wave signal received by the receiving means.

3. The vehicle height detecting system according to claim 1, further comprising:
a vehicle body side transmitting means transmitting a first wireless wave signal from the vehicle body of the vehicle to the transmitting means; wherein the transmitting means comprises
a signal amplifying means amplifying the first wireless wave signal in response to receiving the wireless wave signal transmitted from the vehicle body side transmitting means; and
an amplified signal transmitting means transmitting a second wireless wave signal amplified by the signal amplifying means to the receiving means.

4. The vehicle height detecting system according to claim 3, wherein the vehicle height detecting means comprises a calculation processing means which obtains information of the level of the vehicle body on the basis of a time from the vehicle body side transmitting means transmitting the first wireless wave signal to receiving the second wireless wave signal by the receiving means and/or the intensity of the wireless wave signal received by the receiving means.

5. The vehicle height detecting system according to claim 1, wherein the transmitting means is mounted on a wheel speed sensor which is arranged at the wheel of the vehicle and measures wheel speed at an antilock braking system for performing an antilock braking control of the vehicle.

6. The vehicle height detecting system according to claim 1, wherein the transmitting means is mounted on a tire inflation pressure sensor which is arranged at the wheel of the vehicle and detects a tire inflation pressure at a tire inflation pressure monitoring system for monitoring a tire inflation pressure of the vehicle.

7. The vehicle height detecting system according to claim 2, wherein the transmitting means is mounted on a wheel speed sensor which is arranged at the wheel of the vehicle and measures wheel speed at an antilock braking system for performing an antilock braking control of the vehicle.

8. The vehicle height detecting system according to claim 2, wherein the transmitting means is mounted on a tire inflation pressure sensor which is arranged at the wheel of the vehicle and detects a tire inflation pressure at a tire inflation pressure monitoring system for monitoring a tire inflation pressure of the vehicle.

9. The vehicle height detecting system according to claim 3, wherein the transmitting means is mounted on a wheel speed sensor which is arranged at the wheel of the vehicle and measures wheel speed at an antilock braking system for performing an antilock braking control of the vehicle.

10. The vehicle height detecting system according to claim 3, wherein the transmitting means is mounted on a tire inflation pressure sensor which is arranged at the wheel of the vehicle and detects a tire inflation pressure at a tire inflation pressure monitoring system for monitoring a tire inflation pressure of the vehicle.

11. The vehicle height detecting system according to claim 4, wherein the transmitting means is mounted on a wheel speed sensor which is arranged at the wheel of the vehicle and measures wheel speed at an antilock braking system for performing an antilock braking control of the vehicle.

12. The vehicle height detecting system according to claim 4, wherein the transmitting means is mounted on a tire inflation pressure sensor which is arranged at the wheel of the vehicle and detects a tire inflation pressure at a tire inflation pressure monitoring system for monitoring a tire inflation pressure of the vehicle.

13. The vehicle height detecting system according to claim 1, wherein the vehicle height detecting means estimates the intensity of the wireless wave signal on the basis of a difference of a peak value of the wireless wave signal and a successive peak value of the wireless wave signal.

14. The vehicle height detecting system according to claim 2, wherein the vehicle height detecting means estimates the intensity of the wireless wave signal on the basis of a difference of a peak value of the wireless wave signal and a successive peak value of the wireless wave signal.

15. The vehicle height detecting system according to claim 3, wherein the vehicle height detecting means estimates the intensity of the wireless wave signal on the basis of a difference of a peak value of the wireless wave signal and a successive peak value of the wireless wave signal.

16. The vehicle height detecting system according to claim 4, wherein the vehicle height detecting means estimates the intensity of the wireless wave signal on the basis of a difference of a peak value of the wireless wave signal and a successive peak value of the wireless wave signal.
